(19) United States
(12) Patent Application Publication
(10) Pub. No.: US 2022/0080898 A1
(43) Pub. Date: Mar. 17, 2022

(54) Top Mounted Vehicle Cargo Securing System

(71) Applicants: Marshall Don Jordan, Hampton, VA (US); Aaron Jordan, Newport News, VA (US); Adam Jordan, Hampton, VA (US)

(72) Inventors: Marshall Don Jordan, Hampton, VA (US); Aaron Jordan, Newport News, VA (US); Adam Jordan, Hampton, VA (US)

(21) Appl. No.: 17/156,696

(22) Filed: Jan. 25, 2021

Related U.S. Application Data
(60) Provisional application No. 63/077,738, filed on Sep. 14, 2020.

(51) Int. Cl. B60R 9/048; B60R 9/045

(52) U.S. Cl. CPC B60R 9/048; B60R 9/045

(57) ABSTRACT

This present invention relates to a top-mounted vehicle cargo securing system used to firmly secure luggage containers and protect them from inclement weather atop of a vehicle, as well as to cover a vehicle windshield when the vehicle is not in use. Each of the protective cover and the windshield cover are repositionable between a stowed positioned within the housing of the vehicle cargo securing system, and a deployed position over the respective cargo and windshield, respectively. Each of the protective cover and the windshield cover are repositionable either manually or remotely, and may further comprise a UV protective coating and/or an anti-microbial coating.

### CROSS-REFERENCE TO RELATED APPLICATION

The present application claims priority to, and the benefit of, U.S. Provisional Application No. 63/077,738, which was filed on Sep. 14, 2020 and is incorporated herein by reference in its entirety.

### FIELD OF THE INVENTION

The present invention relates generally to a top mounted cargo securing system for a vehicle, such as a car, truck, camper, RV, or the like. More specifically, the present invention relates to a top-mounted vehicle cargo securing and protection system that mounts to an existing roof rack, and is capable of not only securing and covering top mounted cargo, but also covering the windshield of the vehicle when the vehicle is not in use. Accordingly, the present disclosure makes specific reference thereto. However, it is to be appreciated that certain aspects of the present invention are also useable with other like applications, devices, and methods of manufacture.

### BACKGROUND

Many existing vehicles today, such as cars, trucks, campers, RVs, and the like, have an interior cargo space for transporting luggage and other items in a safe, dry and secure manner from one place to another. However, people oftentimes find that the interior cargo space of their vehicle is insufficient for transporting larger items or a large amount of cargo in any particular trip. Therefore, many such individuals oftentimes must resort to attaching luggage and other cargo to the exterior of the vehicle, such as on the roof, a roof rack or in an open bed of, for example, a pick-up truck.

Unfortunately, transporting items on the top surface of a vehicle or in an open bed of a truck can be both a difficult and time-consuming task. For example, after the luggage or cargo is placed atop of, for example, the roof or a cargo rack, it still must be properly secured thereto to avoid the same from becoming loose or damaged during transport. Additionally, standard rope and bungee cord mounts may be ineffective at fully securing such cargo because they offer minimal contact area with the item being secured, and they offer nothing in terms of protecting the cargo or luggage from the elements, such as rain, snow, sleet, and the sun's harmful UV rays. Similar type of problems exist with respect to transporting cargo and luggage in the open bed of a truck, where it is also susceptible to the elements, damage from being improperly secured during transport, and theft.

Additionally, when vehicles are left outside, snow and ice may accumulate on the windshield of the vehicle which can later be both cumbersome and time consuming for the user to remove, particularly in freezing temperatures or while it is still precipitating. Moreover, during the summer months or in warmer climates, temperatures within the vehicle can soar due to sunlight penetrating through the windshield. Such direct and magnified sunlight through the windshield, and the elevated temperatures that accompany the same, may cause damage to the interior of the vehicle over prolonged periods of time. For example, the interior surfaces of the vehicle's upholstery can become faded, or even crack due to the elevated temperatures within the vehicle. Finally, having an exposed windshield when a vehicle is not in use and unattended can lead to theft of the contents within the vehicle, as the contents of the vehicle are clearly visible to would be criminals and other passersby.

Therefore, there exists a long felt need in the art for a top mounted vehicle cargo securing system that can be attached to an existing luggage rack, and which can be used to firmly secure luggage or other cargo on top of a vehicle. There is also a long felt need in the art for a vehicle cargo securing system that protects the luggage and/or other cargo from inclement weather, such as rain, snow, ice, heavy winds, as well as the sun's harmful UV rays. Additionally, there is a long felt need in the art for vehicle cargo securing system that serves the dual purpose of also providing a reflective windshield cover, thereby keeping the interior of the vehicle relatively cool when the vehicle is parked. Moreover, there is a long felt need in the art for a vehicle cargo securing system that is comprised of a pair of retractable covers for protecting both the cargo stored thereunder and a windshield, such that the respective covers can be conveniently stored when not needed thereby prolonging the useful life of the same and not, for example, blocking or covering a sunroof, etc. Finally, there is a long felt need in the art for a vehicle cargo securing system that is relatively inexpensive to manufacture, and that is both safe and easy to use.

The present invention, as described in various potential embodiments herein, is a top mounted vehicle cargo securing system that is comprised of a housing and two retractable covers that are capable of securing and protecting cargo positioned on top of a vehicle, as well as protecting the windshield of the vehicle. In this manner, the top-mounted vehicle cargo securing system of the present invention accomplishes all of the forgoing objectives, and provides a secure vehicle cargo transportation system. The improved top-mounted vehicle cargo securing system of the present invention is relatively lightweight, and can be easily handled, installed and operated by a user.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a top mounted vehicle cargo securing system to firmly secure luggage and other cargo atop of a vehicle and that protects the same from inclement weather. The top-mounted vehicle cargo securing system preferably comprises an elongated cylindrical-style frame assembly mounted to a front roof bar of a vehicle. The elongated cylindrical-style frame assembly features a roller, a bearing apparatus, a retractable and expandable canvas attached to the bearing apparatus that is capable of being repositioned between a stowed position and a deployed position, and a reflective windshield cover. The reflective windshield cover is also capable of being repositioned between a stowed position and a deployed position. When in the stowed position, each of the protective canvas and the windshield cover are stored within the frame assembly housing. When in the deployed position, the protective canvas extends from the housing towards the rear of the vehicle, over the luggage stored on the luggage rack, and removably attaches to the rear bar of the luggage rack, thereby protecting the luggage or other cargo stored underneath from inclement weather, such as rain, sleet, snow and the like, as well as the sun's harmful UV rays. When in the deployed position, the windshield cover extends from the housing (on the opposite side of the canvas) towards the front of the vehicle, over the vehicle's windshield, and attaches to clips positioned beneath the windshield wipers, thereby protecting the vehicle's windshield from inclement weather, the sun's harmful UV rays and prying eyes, as well as helping to keep the interior temperature of the vehicle relatively cool so that the contents of the same are not damaged.

In one embodiment of the present invention, each of the protective canvas and the windshield cover of the top mounted vehicle cargo securing system are spring loaded and retractable, similar to a spring loaded and retractable window blind, thereby facilitating easy deployment by the user. In another embodiment of the present invention, each of the protective canvas and the windshield cover of the top mounted vehicle cargo securing system may be repositioned between a deployed position and a stowed position via a mechanical means including, but not limited to, a hand crank, a motor drive assembly, etc. In a further embodiment, the motor assembly could be operated remotely by a smart device, such as, but not limited to, a mobile application on smart phone (via, for example, Bluetooth or other wireless technology) or as part of the vehicle's onboard computer system.

In a further embodiment of the present invention, each of the protective cargo canvas and the windshield cover of the top mounted vehicle cargo securing system is comprised of a waterproof material to ensure that the cargo stored thereunder does not become wet from, for example, rain, snow, sleet or the like, and to keep the windshield dry so that it does not, for example, frost over in freezing temperatures. In yet a further embodiment of the present invention, each of the protective cargo canvas and the windshield cover of the top mounted vehicle cargo securing system is comprised of a UV protective materials to protect the cargo stored thereunder from the sun's harmful rays which may otherwise cause the luggage to fade in color or otherwise become damaged. Likewise, the UV protective or reflective material will also protect the sun's rays from penetrating the vehicle's windshield and drastically increasing the interior temperature of the vehicle, discoloring or fading the vehicle interior, etc. In yet another preferred embodiment, each of the protective cargo canvas and the windshield cover of the top mounted vehicle cargo securing system is comprised of a anti-microbial agent or coating that prevents or reduces the likelihood of mold growth on the same.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the top-mounted vehicle cargo securing system of the present invention mounted to an existing vehicle cargo rack in accordance with the disclosed architecture, wherein each of the cargo protective canvas and the protective windshield cover are in a fully deployed position and covering both the cargo and the vehicle's windshield;

FIG. 2 illustrates a perspective view of one potential embodiment of the top-mounted vehicle cargo securing system of the present invention in accordance with the disclosed architecture, wherein each of the cargo protective canvas and the protective windshield cover are in a fully stowed position within the housing;

FIG. 3 illustrates a perspective view of one potential embodiment of the top-mounted vehicle cargo securing system of the present invention mounted to an existing vehicle cargo rack in accordance with the disclosed architecture, wherein the cargo protective canvas is in a fully deployed position and covering the vehicle's cargo and the protective windshield cover is in a fully stowed position, such as may be the case when the vehicle is in motion; and

FIG. 4 illustrates a perspective view of one potential embodiment of the top-mounted vehicle cargo securing system of the present invention mounted to an existing vehicle cargo rack in accordance with the disclosed architecture, wherein the cargo protective canvas is in a fully stowed position and the protective windshield cover is in a fully deployed position and protecting the windshield of the vehicle.

### DETAILED DESCRIPTION

The innovation is now described with reference to the drawings and embodiments, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof

As noted above, there is a long felt need in the art for a top mounted vehicle cargo securing system that can be attached to an existing luggage rack, and which can be used to secure luggage or other cargo on top of a vehicle. There is also a long felt need in the art for a vehicle cargo securing system that protects the luggage or other cargo from inclement weather, and that serves the dual purpose of also providing a reflective windshield cover to keep the interior of the vehicle relatively cool. Moreover, there is a long felt need in the art for a vehicle cargo securing system having a pair of retractable covers for protecting both cargo and the windshield of the vehicle, such that one or both of the respective covers can be conveniently stored when not needed. Finally, there is a long felt need in the art for a vehicle cargo securing system that is relatively inexpensive to manufacture, and that is both safe and easy to use.

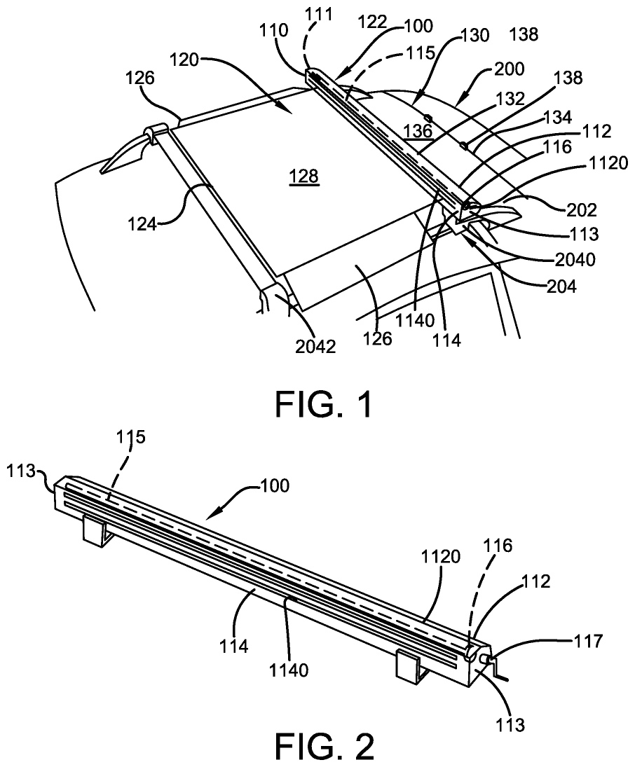

Referring initially to the drawings, FIG. 1 illustrates a perspective view of one potential embodiment of the top-mounted vehicle cargo securing system 100 of the present invention mounted to an existing vehicle cargo rack 204 in accordance with the disclosed architecture, wherein each of the cargo protective canvas 120 and the protective windshield cover 130 are in a fully deployed position and covering both the cargo (not shown) and the windshield 202 of a vehicle 200. More specifically, the vehicle 200 comprises a windshield 202 and a cargo rack 202 positioned on the top of the vehicle 200. The cargo rack 204 is further comprised on a front or forward mount 2040 and a generally parallel and spaced apart rear mount 2042, wherein the front mount 2040 is positioned nearest to the windshield 202, as best shown in FIG. 1.

The top-mounted vehicle cargo securing system 100 is preferably comprised of a housing 110 defining an interior space 111, a protective canvas 120 and a windshield covering 130. The housing 110 is further comprised of a forward face 112 having a longitudinal slot 1120 therein, a pair of opposing sides 113 and a rear face 114 also having a longitudinal opening slot 1140 therein, wherein the forward face 112 faces the front of the vehicle 200 and the rear face 114 faces the rear of the vehicle 200. The housing 110 is preferably mounted to the front mount 2040 of the vehicle's existing cargo rack 204 by any suitable means including, without limitation, clamps, U-bolts, or any other suitable fastener known in the art for removably attaching a first article to a second article. Further, the housing 110 is preferably comprised of a durable, weather-resistant materials, such as, but not limited to an aluminum, a powder-coated or painted metal, a plastic, etc. Notwithstanding the forgoing, it is also contemplated that the housing 110 could be attached to the side bars (i.e., extending therebetween) of a vehicle if, for example, the vehicle does not have a transverse cargo bar that extends from one side of the vehicle to the other.

When in the stowed position, each of the protective canvas 120 and the windshield covering 130 are stored within the interior space 111 of housing 110 and wrapped around a respective roller 115 having a corresponding bearing 116. The roller 115 supporting the protective canvas 120 is preferably positioned within the housing 110 adjacent to the rear face 114, and the roller 115 supporting the windshield cover 130 is preferably positioned within the housing 110 adjacent to the forward face 115. As explained more fully below, each of the protective canvas 120 and the windshield covering 130 are also repositionable between a stowed position (i.e., within the interior space 111) and a deployed position, wherein each of the protective canvas 120 and the windshield covering 130 extend outwardly from housing 110 through a respective one of longitudinal slot 1120 and opening 1140 in the rear face 114 of the housing.

The rollers 115/bearings 116 may be spring loaded and retractable, similar to a spring loaded and retractable window blind, thereby facilitating relatively easy deployment of the protective canvas 120 and/or the windshield covering 130 by the user. In another embodiment of the present invention, each of the protective canvas 120 and the windshield cover 130 of the top mounted vehicle cargo securing system 100 may be repositioned between a deployed position and a stowed position via a mechanical means including, but not limited to, a hand crank 117 positioned on one of sides 113 as best shown in FIG. 2, a motor drive assembly (not shown), or other repositioning means. In a further embodiment, the motor assembly could be operated remotely by a smart device (not shown), such as, but not limited to, a mobile application on smart phone (via, for example, Bluetooth or other wireless technology) or as part of the vehicle's onboard computer system.

The protective canvas 120 is generally rectangular in shape, and is comprised of an inboard end 122 that is attached to one of rollers 115, an outboard end 124 that extends outwardly and away from the housing 110 in the direction of the rear mount 2042 of the roof rack 104, and an exterior side or surface 128. More specifically, in use, the protective canvas 120 is repositioned from the stowed position within housing 110 in the direction of the rear mount 2042 of the roof rack 104 and over the cargo stored on top of the vehicle 200 between the respective front mount 2040 and the rear mount 2042. The outboard end 124 of protective canvas 120 may be removably attached to the rear mount 2042 of the roof rack 104 by any suitable means, such as clamps, clips, etc. In this manner, the protective canvas 120 secures the cargo against the roof of the vehicle 200, and protects the same from inclement weather, such as rain, sleet, snow, etc., as well as potential theft.

The retractable and expandable canvas 120 may be formed of a single or multiple layers of a waterproof, rubber-like material including, without limitation, a synthetic rubber, closed cell foam, open cell foam, silicone, neoprene, or any other suitable elastic material that is able to stretch in one or more dimensions. The stretchability, length and thickness of the protective canvas 120 may vary depending on the layer types and thicknesses utilized. The exterior side or surface 128 of the protective canvas 120 may be further comprised of a UV protective or reflective coating to block or reflect UV rays from the sun and protect the cargo stored thereunder from the same. In a further embodiment of the present invention, the exterior side or surface 128 of the protective canvas 120 may be further comprised of an anti-microbial coating to prevent or at least reduce the growth of mold on the protective canvas 120, for example, if it is stored in a wet condition within the housing 110.

Similarly, the windshield cover 130 is also generally rectangular in shape, and is comprised of a proximal end 132 that is attached to one of rollers 115, a distal end 134 that extends outwardly and away from the housing 110 in the direction of the front of the vehicle 200, and an exterior side or surface 136. More specifically, in use, the windshield cover 130 is repositioned from the stowed position within housing 110 in the direction of the front of the vehicle 200 and over the windshield 202. The distal end 134 of windshield cover 130 may be removably attached to the vehicle hood by any suitable means, such as clasps 138, clamps, clips, etc. In this manner, the windshield cover 130 covers the windshield 202 of the vehicle 200, and protects the same from accumulating snow, ice, or other debris, while also blocking or reflecting the sun's harmful UV rays. The retractable windshield cover 130 may be formed of a single or multiple layers of a waterproof, reflective material including, without limitation, an aluminum foil, etc., or any other suitable material that is capable of reflecting sunlight and/or UV rays. In a further embodiment of the present invention, the exterior side or surface 136 of the windshield cover 130 may be further comprised of an anti-microbial coating to prevent or at least reduce the growth of mold on the windshield cover 130, for example, if it is stored in a wet condition within the housing 110.

FIG. 2 illustrates a perspective view of one potential embodiment of the improved top-mounted vehicle cargo securing system 100 of the present invention in accordance with the disclosed architecture, wherein each of the cargo protective canvas 120 and the protective windshield cover 130 are in a fully stowed position within the housing 110. More specifically, when in the stowed position, each of the cargo protective canvas 120 and the protective windshield cover 130 are fully wound around a respective one of rollers 115 that extend longitudinally within the housing 110 between the opposing sides 113.

When a user (not shown) desires to deploy one or both of the cargo protective canvas 120 and the protective windshield cover 130, the user may manually pull, for example, the outboard end 124 of the protective canvas 120 from the opening 1140 in the rear face 114 and in the direction of the rear mount 2042 of the cargo rack 204, over the cargo to be secured thereby, and removably attach the protective canvas 120 to the rear mount. Alternatively, the user may use the crank assembly 117 on the side 113 of the housing 110 to reposition the protective canvas 120 relative to the housing 110, which is in mechanical communication with roller 115 via bearing 116. In a further embodiment of the present invention, a user may reposition the cargo protective canvas 120 by a motor assembly (not shown) operated remotely by a smart device, such as, but not limited to, a mobile application on smart phone (via, for example, Bluetooth or other wireless technology) or as part of the vehicle's 200 onboard computer system.

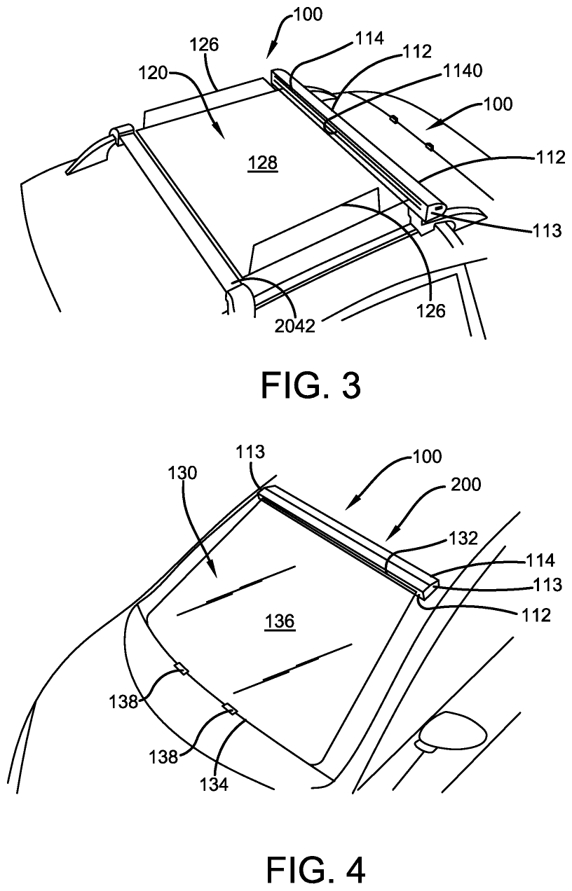

FIG. 3 illustrates a perspective view of one potential embodiment of the improved top-mounted vehicle cargo securing system 100 of the present invention mounted to an existing vehicle cargo rack 204 in accordance with the disclosed architecture, wherein the cargo protective canvas 120 is in a fully deployed position and covering the vehicle's cargo, and the protective windshield cover 130 is in a fully stowed position, such as may be the case when the vehicle 200 is in motion. As best shown in this FIG. 3, the cargo protective canvas 120 may further comprise a pair of opposing side panels 126 that are comprised of the same material as cargo protective canvas 120 and may be folded outwardly from the remainder of the cargo protective canvas 120 once fully deployed to add additional protection to the cargo stored thereunder.

Each of the opposing side panels 126 may extend from the inboard end 122 to the outboard end of 124 of the protective canvas 120, as best shown in FIGS. 1 and 3, and may be integrally formed with the protective canvas 120, or fixedly or removably attached thereto via, for example, hook and loop fasteners (not shown). It is also contemplated that each of opposing side panels 126 could further comprised a magnet attached thereto for securing the outward edge of the side panel (i.e., that edge opposite of the main body of the protective canvas 120) for securing the same to the metallic surface of the vehicle 200.

FIG. 4 illustrates a perspective view of one potential embodiment of the improved top-mounted vehicle cargo securing system 100 of the present invention mounted to an existing vehicle cargo rack 204 in accordance with the disclosed architecture, wherein the cargo protective canvas 120 is in a fully stowed position and the protective windshield cover 130 is in a fully deployed position and protecting the windshield 202 of the vehicle 200. More specifically, when a user desires to deploy the windshield cover (e.g., when the vehicle is not in use), the user (not shown) would simply manually pull the distal end 134 of the windshield cover 130 from the slot 1120 in the forward face 114 and in the direction of the front of the vehicle and over the windshield 202, and removably attach the windshield cover 130 to the vehicle via clasps 138 or any other suitable mechanical means.

Alternatively, the user may use the crank assembly 117 on the side 113 of the housing 110 to reposition the windshield cover 130 relative to the housing 110, which is in mechanical communication with roller 115 via bearing 116. In a further embodiment of the present invention, a user may reposition one or both of the cargo protective canvas 120 and the protective windshield cover 130 by a motor assembly (not shown) operated remotely by a smart device, such as, but not limited to, a mobile application on smart phone (via, for example, Bluetooth or other wireless technology) or as part of the vehicle's 200 onboard computer system.

In this manner, the top-mounted vehicle cargo securing system 100 of the present invention accomplishes all of the forgoing objectives, and provides a secure vehicle cargo transportation system, as well as protection for the windshield and interion of the vehicle. Furthermore, the improved top-mounted vehicle cargo securing system 100 of the present invention is relatively lightweight, and can be easily handled, installed and operated by a single user.

Certain terms are used throughout the following description and claim to refer to particular features or components. As one skilled in the art will appreciate, different persons may refer to the same feature or component by different names. This document does not intend to distinguish between components or features that differ in name but not structure or function. As used herein “luggage” and “cargo” are interchangeable and refer to the articles kept on the top of a vehicle during transportation from one place to the other. Also the word “handle” or “crank” is used synonymously for a component or a bearing apparatus to expand or retract one or both of the protective canvas 120 and the windshield cover 130.

Notwithstanding the forgoing, the components used to make cargo securing system 100 of the present invention can be of any suitable size, shape, color, style and configuration as is known in the art without affecting the overall concept of the invention, provided that it accomplishes the above stated objectives. One of ordinary skill in the art will appreciate that the shape and size of the various components cargo securing system 100, as shown in the FIGS., are for illustrative purposes only, and that many other shapes, sizes and arrangement of the various components are well within the scope of the present disclosure. Although the dimensions of the cargo securing system 100 and its various components (e.g., length, width, and height) are important design parameters for good performance, the invention and its components may be any shape, size, color and style that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A top-mounted vehicle cargo securing system comprising:
a housing comprised of a forward face having an elongated slot therein and a rear face having an elongated opening therein;
a protective canvas attached to a first roller; and
a windshield cover attached to a second roller.

2. The top-mounted vehicle cargo securing system according to claim 1 further comprising a bearing.

3. The top-mounted vehicle cargo securing system according to claim 1 further comprising at least one hand crank for repositioning at least one of the protective canvas and the windshield cover.

4. The top-mounted vehicle cargo securing system according to claim 1, wherein each of the protective canvas and the windshield cover are extendible outwardly from the housing in opposite directions.

5. The top-mounted vehicle cargo securing system according to claim 1, wherein the protective canvas is repositionable between a stowed position within the housing and a deployed position outside of the housing, and further wherein, in the deployed position, the protective canvas extends outwardly through the elongated opening in the rear face of the housing.

6. The top-mounted vehicle cargo securing system according to claim 1, wherein the windshield cover is repositionable between a stowed position within the housing and a deployed position outside of the housing, and further wherein, in the deployed position, the windshield cover extends outwardly through the elongated slot in the forward face of the housing.

7. The top-mounted vehicle cargo securing system according to claim 1, wherein the protective canvas is comprised of a UV protective coating and an anti-microbial coating.

8. The top-mounted vehicle cargo securing system according to claim 1, wherein the windshield cover is comprised of a UV protective coating and an anti-microbial coating.

9. The top-mounted vehicle cargo securing system according to claim 1, wherein at least one of the protective canvas and the windshield cover is repositionable between a stowed position and a deployed position via a wireless connection with a smart device.

10. The top-mounted vehicle cargo securing system according to claim 1, wherein at least one of the protective canvas and the windshield cover is repositionable between a stowed position and a deployed position via an onboard computer system in a vehicle.

11. The top-mounted vehicle cargo securing system according to claim 5, wherein in the stowed position the protective canvas is wrapped around the first roller.

12. A cargo securing system attached to a cargo rack of a vehicle, wherein the cargo securing system comprises:
a housing comprised of a forward face, a pair of opposing sides, and a rear face;
a protective canvas attached to a first roller, wherein the first roller is positioned within the housing and adjacent to the rear face; and
a windshield cover attached to a second roller, wherein the second roller is positioned within the housing and adjacent to the forward face.

13. The cargo securing system according to claim 12 further comprising a bearing, and wherein each of the first and second rollers are spring loaded.

14. The cargo securing system according to claim 12, wherein each of the protective canvas and the windshield cover are extendible outwardly from the housing in opposite directions.

15. The cargo securing system according to claim 12, wherein the protective canvas is repositionable between a stowed position within the housing and a deployed position outside of the housing, and further wherein, in the deployed position, the protective canvas extends outwardly through an elongated opening in the rear face of the housing.

16. The cargo securing system according to claim 12, wherein the windshield cover is repositionable between a stowed position within the housing and a deployed position outside of the housing, and further wherein, in the deployed position, the windshield cover extends outwardly through an elongated slot in the forward face of the housing.

17. The top-mounted vehicle cargo securing system according to claim 1, wherein each of the protective canvas and the windshield cover is comprised of a UV protective coating and an anti-microbial coating.

18. A combination device attached to a cargo rack of a vehicle, wherein the combination device comprises:
a housing comprising an interior space, a first opening in a first surface of the housing and a second opening in a second surface of the housing;
a protective canvas attached to a first roller, wherein the first roller is positioned within the interior space and the protective canvas extends through the first opening; and
a windshield cover attached to a second roller, wherein the second roller is positioned within the housing and windshield cover extends through the second opening.

19. The combination device according to claim 18, wherein each of the protective canvas and the windshield cover is comprised of a UV protective coating and an anti-microbial coating.

20. The combination device according to claim 18, wherein each of the protective canvas and the windshield cover extend in opposite directions.
